(19) United States
(12) Patent Application Publication
(10) Pub. No.: US 2020/0057593 A1
(43) Pub. Date: Feb. 20, 2020

(54) DISPLAY METHOD AND DISPLAY CONTROL DEVICE

(71) Applicant: NEC DISPLAY SOLUTIONS, LTD., Tokyo (JP)

(72) Inventor: Nobuhide FUJIOKA, Tokyo (JP)

(73) Assignee: NEC DISPLAY SOLUTIONS, LTD., Tokyo (JP)

(21) Appl. No.: 16/487,599

(22) PCT Filed: Mar. 3, 2017
(86) PCT No.: PCT/JP2017/008626

§ 371 Date: Aug. 21, 2019

(51) Int. Cl. G06F 3/147; G09F 19/00

(52) U.S. Cl. CPC G06F 3/147; G09F 19/00

(57) ABSTRACT

This display method includes: a detection step of detecting that a portable terminal has approached a display device; a step of, after the detection step, selecting desired content to be displayed on the display device based on preset area information associated with the display device and preset desire information associated with the portable terminal; and a step of transmitting, to the display device, the desired content selected in the step of selecting the desired content.

### TECHNICAL FIELD

The present invention relates to a display method and a display control device

### BACKGROUND ART

Display devices installed in public locations, such as railway stations, bus stops, service areas, and airports, display content that notify passersby of various types of information including directions, notices, and advertisements. For example, disclosed in Patent Document 1 is a technique that displays an advertisement matched to the age composition and gender composition of passersby on an information providing display system described therein. Furthermore, disclosed, in Patent Document 2 is a system that captures an image and determines the attributes of passersby using an advertisement information providing system described therein.

Although the content displayed on such display devices reflects the attribute information of the passersby, the content does not necessarily include information whose acquisition is desired by the passersby. In other words, conventional information providing systems have a problem that they are unable to appropriately display content whose acquisition is desired by the passersby that pass near the display device.

### PRIOR ART DOCUMENTS

### Patent Documents

[Patent Document 1] Japanese Unexamined Patent Application, First Publication No. 2004-157498

[Patent Document 2] Japanese Unexamined Patent Application, First Publication No. 2009-211284

### SUMMARY OF THE INVENTION

### Problem to be Solved by the Invention

The present invention has been developed in light of the above aspects. An object of the present invention is to provide a display method, a display control device, and a display system that appropriately display on a display device, content desired by passersby that pass near the display device.

### Means for Solving the Problem

In order to achieve the object described above, a display method of the present invention includes: a detection step of detecting that a portable terminal has approached a display device; a step of, after the detection step, selecting desired content to be displayed on the display device based on preset area information associated with the display device and preset desire information associated with the portable terminal; and a step of transmitting, to the display device, the desired content selected in the step of selecting the desired content.

In order to achieve the object described above, a display control device of the present invention includes: a selection unit that, when it is detected that a portable terminal has approached a display device, selects desired content based on preset area information associated with the display device and preset desire information associated with the portable terminal; and a transmission unit that transmits, to the display device, the desired content selected by the selecting unit.

### Effect of the Invention

According to the present invention, content which is appropriate for passersby that pass near a display device can be displayed on a display device.

### BRIEF DESCRIPTION OF THE DRAWINGS

FIG. 1 is a system configuration diagram of a display system that uses a display method of a first exemplary embodiment.

FIG. 2 is a configuration diagram showing the configuration of a display control device that uses the display method of the first exemplary embodiment.

FIG. 3 is an example of desire information used in the display method of the first exemplary embodiment.

FIG. 4 is an example of area information used in the display method of the first exemplary embodiment.

FIG. 5 is an example of content information used in the display method of the first exemplary embodiment.

FIG. 6 is a flowchart showing the flow of the display method of the first exemplary embodiment

FIG. 7 is an operation example using the display method of the first exemplary embodiment.

FIG. 8 is a flowchart showing the flow of a display method of a second exemplary embodiment.

FIG. 9 is a configuration diagram showing the configuration of a display control device of a third exemplary embodiment.

FIG. 10 is a configuration diagram showing the configuration of a display control device of a fourth exemplary embodiment.

### EMBODIMENTS FOR CARRYING OUT THE INVENTION

Hereunder, a display method according to an exemplary embodiment will be described with reference to the drawings.

### First Exemplary Embodiment

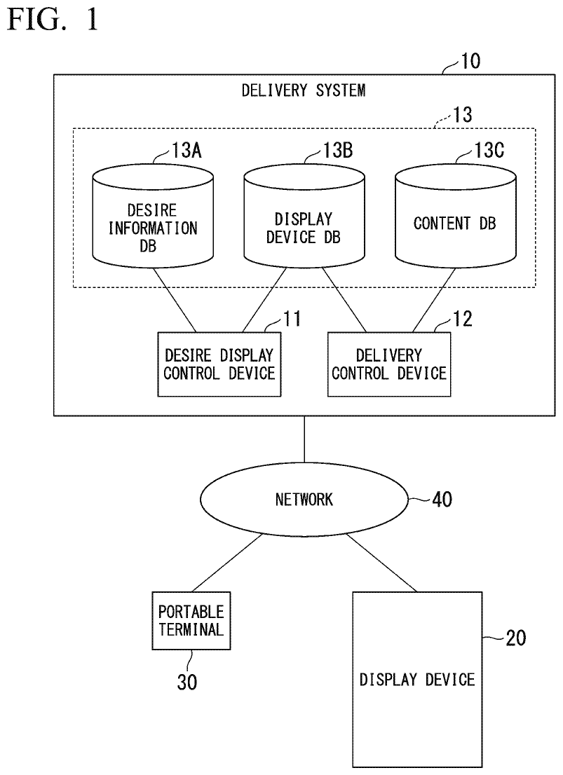

FIG. 1 is a system configuration diagram of a display system 1 that uses a display method of the present exemplary embodiment. The display system 1 includes a delivery system 10, a display device 20, and a portable terminal 30. The delivery system 10, the display device 20, and the portable terminal 30 are each connected to a network 40. The network 40 includes some or all of a WAN (Wide Area Network), a LAN (Local Area Network), the Internet, a provider device, a wireless base station, a dedicated line, and the like. The delivery system 10, the display device 20, and the portable terminal 30 communicate with each other via the network 40. One or more delivery systems 10, display devices 20, and portable terminals 30 may be provided.

The delivery system 10 includes, for example, a desire display control device 11, a delivery control device 12, and a database 13. The database 13 includes a desire information DB 13A a display device DB 13B, and a content DB 13C.

The desire information DB 13A contains formation (desire information) whose acquisition is desired by a passerby (user of the portable terminal 30) that passes near the display device 20. The display device DB 13B contains information related to the installation position of the display device 20. The content DB 13C contains image information which represents the content to be shown on the display device 20.

When the user of a portable terminal 30 approaches the display device 20, the desire display control device 11 selects content to be displayed on the display device 20 based on information recorded in the desire information DB 13A and the display device DB 13B. Because the desire information DB 13A contains the user's desire information, the desire display control device 11 is capable of selecting content (desired content) that includes information whose acquisition is desired by the user. Further, the desire display control device 11 outputs information representing the selected desired content to the display device 20 via the delivery control device 12 and the network 40. The display device 20 displays the desired content delivered from the delivery control device 12.

As a result, in the display system 1, desired content that has been selected based on the user's desire information and area information, which represents the installation location of the display device 20 or an area related to the location thereof, can be displayed on the display device 20 when the user approaches the display device 20, and with a timing such that the display screen of the display device 20 is viewable.

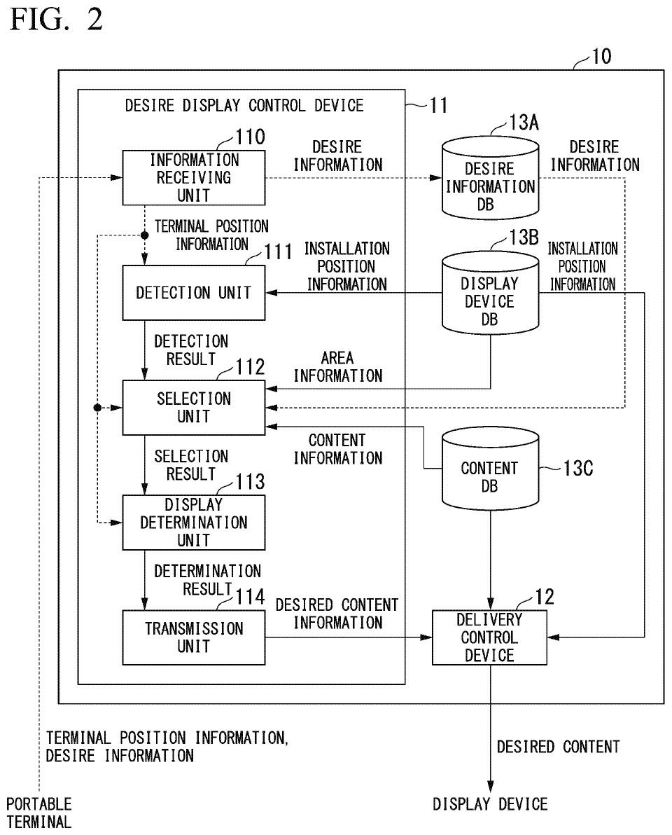

FIG. 2 is a system configuration diagram of a delivery system 10 that uses the display method of the present exemplary embodiment. In FIG. 2, the network 40 in FIG. 1 has been omitted. As already described for FIG. 1, the portable terminal 30 performs transmission of information to the delivery system 10 via the network 40. Furthermore, the delivery system 10 performs transmission of desired content to the display device 20 via the network 40.

The desire display control device 11 and the delivery control device 12 represent a computer that includes a processor such as a CPU (Central Processing Unit), and a program memory stores programs which are executed by the processor. The desire display control device 11 includes an information receiving unit 110, a detection unit 111, a selection unit 112, a display determination unit 113, and a transmission unit 114.

The information receiving unit 110, the detection unit 111, the selection unit 112, the display determination unit 113, and the transmission unit 114 are each realized by, for example, a processor such as a CPU executing a program stored in a program memory. Furthermore, some or all of these functional units may be realized by hardware such as an LSI (Large Scale Integration), an ASIC (Application Specific Integrated Circuit), or a FPGA (Field-Programmable Gate Array).

The information receiving unit 110 receives terminal position information from the portable terminal 30. The terminal position information includes information related to the current position of the portable terminal 30. The information receiving unit 110 outputs the terminal position information received from the portable terminal 30 to the detection unit 111, the selection unit 112, and the display determination unit 113, respectively. When it is detected that the portable terminal 30 has approached the display device 20, the information receiving unit 110 may receive information from the display device 20 indicating that the portable terminal 30 has approached the display device 20. For example, the display device 20 notifies the delivery system 10 when communication with a portable terminal 30 that has approached the display device 20 becomes possible by means of near field communication such as infrared or Bluetooth (registered trademark). As a result, the information receiving unit 110 receives information from the display device 20 indicating that the portable terminal 30 has approached the display device 20.

The information receiving unit 110 receives desire information from the portable terminal 30. The desire information received from the portable terminal 30 includes information whose acquisition is desired by the user of the portable terminal 30. The information receiving unit 110 associates the desire information received from the portable terminal 30 with an identification number of the portable terminal 30, and records the information for each user in the desire information DB 13A.

The detection unit 111 inputs terminal position information from the information receiving unit 110. Furthermore, the detection unit 111 refers to installation position information recorded in the display device DB 13B. The installation position information includes information related to the installation location of the display device 20.

Further, the detection unit 111 detects that the portable terminal 30 has approached the display device 20, based on terminal position information and installation position information. In the present application, it is assumed that “the portable terminal 30 has approached the display device 20” when it is predicted that a person having normal vision is capable of viewing the display screen of the display device 20 from the position specified by the terminal position information. For example, the detection unit 111 can detect that the portable terminal 30 has approached the display device 20 when the portable terminal 30 enters a predetermined judgment area set around the installation location of the display device 20.

The detection unit 111 outputs to the selection unit 112 a detection result indicating that the portable terminal 30 has approached the display device 20 (presented as a “detection result” in FIG. 2).

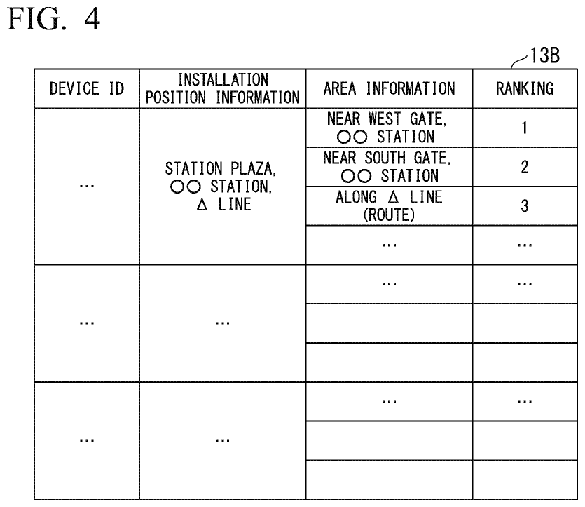

The selection unit 112 inputs the detection result from the detection unit 111. If the detection result indicates that the portable terminal 30 has approached the display device 20, the selection unit 112 refers to area information recorded in the display device DB 13B. The area information includes information representing the installation location of the display device 20 and areas related to the location thereof, such as areas that are within walking distance from the installation location of the display device 20 and, if the installation location is in front of a railway station, the areas that can be accessed by train from the station (refer to FIG. 4).

Furthermore, the selection unit 112 refers to desire information recorded in the desire information DB 13A. The desire information represents information categories whose acquisition is desired by the user of the portable terminal 30, and includes information related to categories having a high probability of attracting the user's interest if the information is displayed on the display device 20.

Further, based on the referenced area information and desire information, the selection unit 112 selects content from within the content recorded in the content DB 13C which is associated with the installation location of the display device 20 and areas related to the location thereof, and is also content related to a category that the user of the portable terminal 30 would particularly like to see.

Here, the selection unit 112 may select desired content using terminal position information instead of or together with the desire information. In this case, the selection unit 112 is capable of selecting desired content based on a position history of the portable terminal 30. For example, if the selection unit 112 establishes from the position history of the portable terminal 30 that a specific store has been frequently visited, the category which includes the store can be treated as the user's desire information.

The area information may include information representing a plurality of areas related to the installation location of the display device 20 (refer to FIG. 4). If a plurality of areas is represented by the area information, the selection unit 112 may select one area from within the plurality of areas based on the desire information and content recorded in the content DB 13C. For example, the selection unit 112 selects an area from among the plurality of areas which has a large amount of content related to the category desired to be viewed by the user as indicated in the desire information. Consequently, more content that attracts the user's interest can be displayed on the display device 20.

Furthermore, if a plurality of areas is represented in the area information, the selection unit 112 may select a specific area according to a ranking at the time of selection of the desired content which has been set by the administrator or the like that installed the display device 20.

Here, the ranking refers to a priority used when selecting one area from among a plurality of areas in a case where a plurality of areas is represented in the area information. For example, the ranking is set beforehand by the administrator or the like that installed the display device 20. In this case, the selection unit 112 selects, for example, content related to an area in which the administrator or the like set a high ranking.

The ranking may indicate the order in which areas become selected, or may represent the probability of selecting an area. If the ranking indicates the order in which areas become selected, specific areas set with a high ranking are always selected as long as the ranking of the plurality of areas is not rewritten. In a case where the ranking indicates the probability of selecting an area, for example, given two areas in which one area is set with a high ranking and one area is set with a low ranking, for every ten times the desired content is displayed, content related to the area set with the high ranking is displayed seven times, and content related to the area set with the low ranking is displayed the remaining three times.

Furthermore, if a plurality of areas is represented in the area information, the selection unit 112 may select a specific area from among the plurality of areas according to a position history of the portable terminal 30 and a ranking of the areas set beforehand by the administrator or the like. In this case, for example, if there is a plurality of areas frequently visited by the user, the ranking set with a high ranking by the administrator or the like is selected. As a result, the selection unit 112 is capable of selecting, for example, content related to an area frequently visited by the user, and related to an area set with a high ranking by the administrator or the like.

Furthermore, in a case where the selection unit 112 selects desired content, determination of whether or not area information is used may be made based on information that has been set beforehand by the user of the portable terminal 30. In this case, if the user sets the display device 20 to display desired content selected based on area information, desired content selected based on both area information and desire information is displayed according to the processing performed by the selection unit 112 described above. On the other hand, if the user sets the display device 20 to not display desired content selected based on the area information, desired content selected based only on desire information is displayed irrespective of the area information. The selection unit 112 outputs to the display determination unit 113 a result representing the selected desired content (presented as a “selection result” in FIG. 2).

The display determination unit 113 inputs terminal position information from the information receiving unit 110. The display determination unit 113 detects the direction in which a portable terminal 30 moves (movement direction) based on the history of the terminal position information. Further, the display determination unit 113 determines whether or not to display desired content on the display device 20 based on at least either the terminal position or the movement direction. The method for determining whether or not the display determination unit 113 displays desired content on the display device 20 will be described in detail below.

The display determination unit 113 transmits to the transmission unit 114 a determination result (presented as a “determination result” in FIG. 2).

The transmission unit 114 receives input of the selection result from the display determination unit 113. The transmission unit 114 transmits, based on the selection result, information representing the desired content selected by the selection unit 112 to the delivery control device 12 (presented as “desired content information” in FIG. 2).

The delivery control device 12 receives from the transmission unit 114 desired content information to be displayed on the display device 20. Based on the received desired content information, the delivery control device 12 refers to the installation position information recorded in the display device DB 13B and acquires the installation position information for the display device 20 on which the desired content is to be displayed.

The delivery control device 12 delivers desired content to the display device 20, which displays desired content specified based on the acquired installation position information.

The database 13 has a recording medium for recording data. The recording medium included in the database 13 uses, for example, a HDD (Hard Disc Drive), a flash memory, an EEPROM (Electrically Erasable Programmable Read Only Memory), or a RAM (Random Access Memory). The database 13 includes the desire information DB 13A, the display device DB 13B, and the content DB 13C.

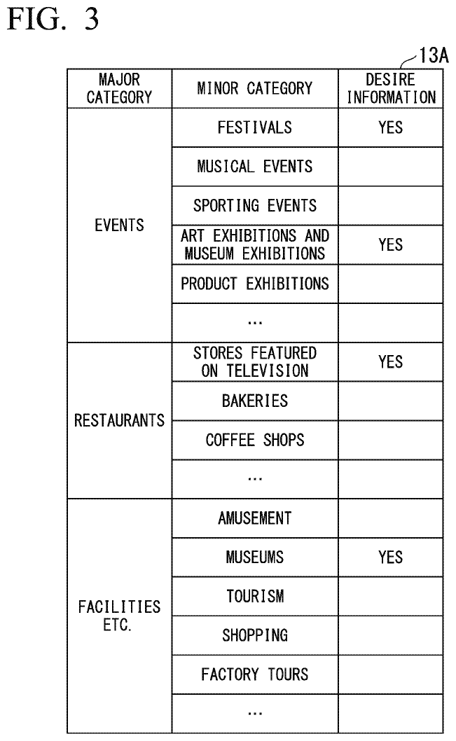

The desire information DB 13A will be described using FIG. 3. FIG. 3 is a diagram showing an example of information recorded in the desire information DB 13A.

The table shown in FIG. 3 is created in the desire information DB 13A for each portable terminal 30 identification number (presented as a “terminal ID” in FIG. 3).

The installation position information of the display device 20 is recorded in the desire information DB 13A. In the example shown in FIG. 3, major categories such as events, restaurants, and facilities are recorded. Furthermore, a plurality of minor categories associated with each of the major categories is recorded. In the example shown in FIG. 3, “festivals”, “musical events”, and “sporting events” are recorded as minor categories associated with the major category “area events”. Furthermore, “stores featured on television”, “bakeries”, and “coffee shops” and the like are recorded as minor categories associated with the major category “area restaurants”. Moreover, “amusement”, “museums”, “tourism” “shopping”, and “factory tours” and the like are recorded as minor categories associated with the major category “area facilities”.

In the example of FIG. 3, categories desired by the user are recorded in the desire information DB 13A for each of the categories such as events, restaurants, and facilities, however itis not limited to this. For example, attribute information such as the user's age and gender may be recorded, and information such as the user's first language (the user's most proficient language, often referred to as a mother tongue) may also be recorded.

The display device DB 13B will be described using FIG. 4. FIG. 4 is a diagram showing an example of information recorded in the display device DB 13B.

The table shown in FIG. 4 is created in the display information DB 13B for each display device 20 identification number (presented as a “device ID” in FIG. 4).

As shown in FIG. 4, installation position information is stored in the display device DB 13B in association with the device ID. Moreover, a plurality of area information items for the area related to the installation position information is recorded in the display device DB 13B. Further, a ranking corresponding to each of the plurality of area information items is recorded in the display device DB 13B. The area information is determined beforehand by the administrator or the like at the time of installation of the display device 20. The installation position information and area information are, for example, recorded beforehand by the administrator or the like at the time of installation of the display device 20 with consideration given to, for example, the size and installation direction of the display device 20, and the installation height.

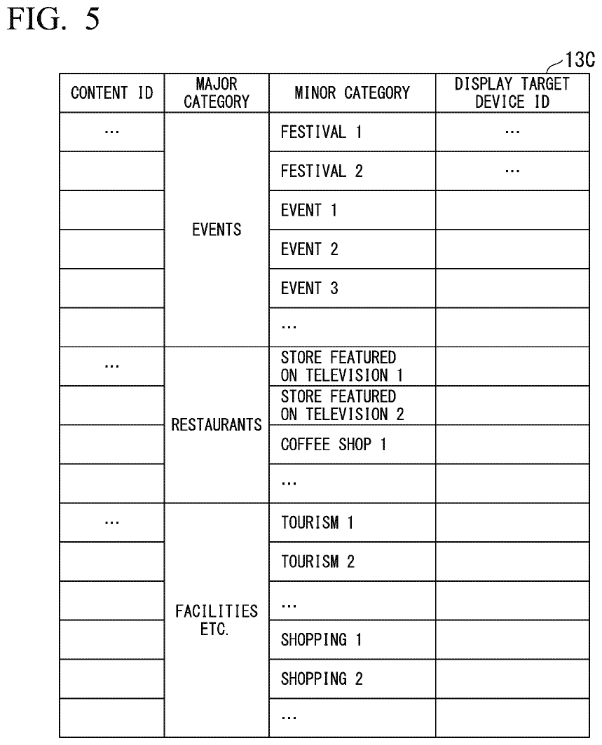

The content DB 13C will be described using FIG. 5. FIG. 5 is a diagram showing an example of information recorded in the content DB 13C. The content to be displayed on the device 20 is recorded in the content DB 13C.

As shown in FIG. 5, information representing a content classification is recorded in the content DB 13C in association with the content ID. The information representing the content classification records major categories such as events, restaurants, and facilities, Furthermore, a plurality of minor categories associated with each of the major categories is recorded. These major categories and minor categories in the content DB 13C correspond to the major categories and minor categories in the desire information DB 13A.

Moreover, as shown in FIG. 5, a display target device ID is recorded in the content DB 13C in association with the content ID. The display target device ID represents identifying information of the display device on which the content is to be displayed. For example, if the major category of the content is “event” and the minor category is “festival 1”, the device IDs of display devices installed in the area of “festival 1” and along the route to the event location are recorded.

Returning to FIG. 2, the display device 20 displays content delivered from the delivery control device 12. The display device 20 is, for example, a liquid crystal display or an organic EL (Electroluminescence) display having a communication function.

The portable terminal 30 transmits desire information and terminal position information to the desire display control device 11. The portable terminal 30 is, for example, a portable communication device equipped with a wireless communication device such as a mobile phone, a game console, or a PDA (Personal Digital Assistant).

The portable terminal 30 has a position information acquisition unit (not shown in the figure) that acquires position information using a GPS (Global Positioning System) or the like.

Moreover, the portable terminal 30 includes a desire information acquisition unit (not shown in the figure) that acquires the user's desire information. The desire information acquisition unit, for example, acquires desire information specified by the user carrying the portable terminal 30 using a web browser or a dedicated application.

Further, the portable terminal 30 includes an information transmission unit (not shown in the figure) that transmits both desire information and terminal position information to the information receiving unit 110, and transmits the position information of the portable terminal 30 acquired by the position information acquisition unit described above, and the desire information acquired by the desire information acquisition unit, to the information receiving unit 110 via the network 40.

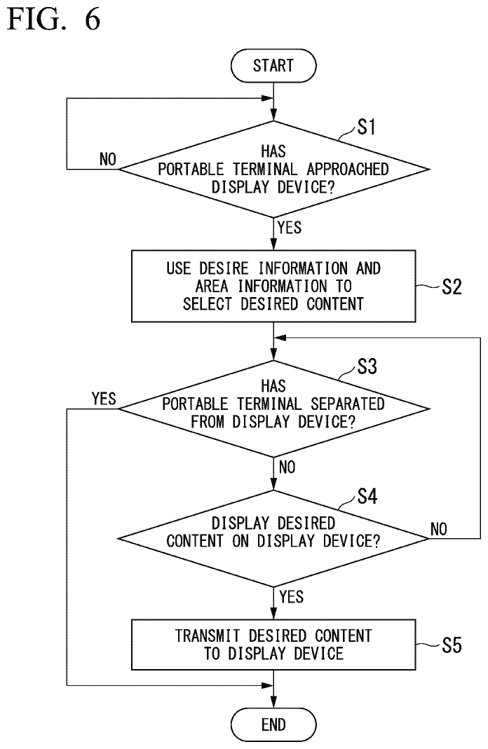

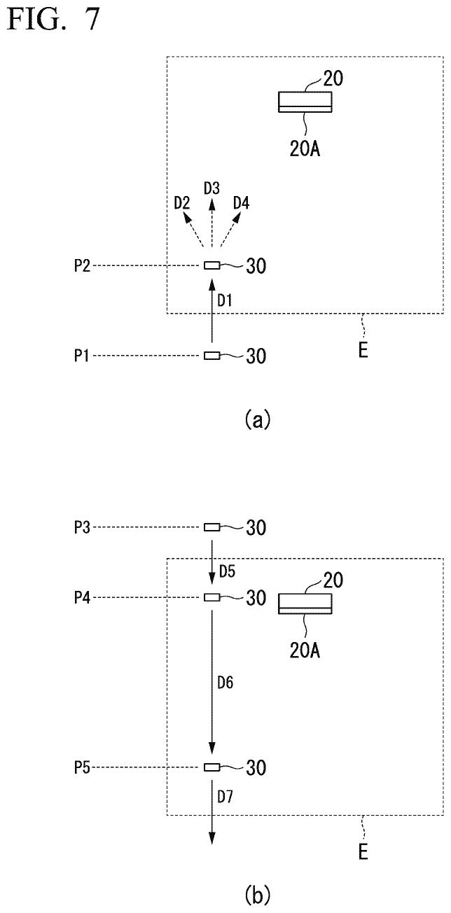

Here, a method for causing the display determination unit 113 to determine whether or not to display desired content on the display device 20 is described using FIG. 6 and FIG. 7.

FIG. 6 is a flowchart showing the operation of the delivery system 10. FIG. 7 is a figure that describes the positional relationship between the display device 20 and the portable terminal 30. FIG. 7(a) is a diagram showing an example of a case where the portable terminal 30 approaches the display device 20. FIG. 7(b) is a diagram showing another example of a case where the portable terminal 30 approaches the display device 20.

Firstly, the detection unit 111 uses terminal position information and installation position information to detect that the portable terminal 30 has approached the display device 20 (step S1).

Specifically, the detection unit 111 detects that the position of the portable terminal 30, which is determined based on terminal position information, is inside a judgment area E (refer to FIG. 7(a) and FIG. 7(b)). Here, the judgment area E is set around the installation location of the display device 20, which is determined based on installation position information. That is to say, the detection unit 111 detects that the user carrying the portable terminal 30 is in a position where the display screen of the display device 20 is viewable. The detection unit 111 outputs the detection result to the selection unit 112.

If the portable terminal 30 has approached the display device 20 (step S1, Yes), the selection unit 112 uses desire information and installation position information to select the desired content (step S2). The selection unit 112, for example, refers to the desire information associated with the terminal ID, and also refers to the area information associated with the device ID. Then, the selection unit 112 selects the desired content based on desire information whose acquisition is desired by the user carrying the portable terminal 30, and area information for the area around the installation location of the display device 20. The selection unit 112 outputs the selected desired content to the display determination unit 113.

On the other hand, if the selection unit 112 detects that the portable terminal 30 has not approached the display device 20 (step S1, No), that is to say, the position of the portable terminal 30 specified by the terminal position information is not inside the judgment area E, the process returns to the processing described in step S1.

Next, the display determination unit 113 detects that the portable terminal 30 has separated from the display device 20 based on the positional relationship between the display device 20 and the portable terminal 30 (step S3). Here, in the present application, it is assumed that “the portable terminal 30 has separated from the display device 20” when it is predicted that a person having normal vision is unable to view the display screen of the display device 20 from the position specified by the terminal position information.

Specifically, the display determination unit 113 detects that the portable terminal 30 has separated from the display device 20 when the position of the portable terminal 30 determined based on terminal position information falls outside the area of the judgment area E set around the installation location of the display device 20, which is determined based on installation position information.

If the display determination unit 113 detects that the portable terminal 30 has separated from the display device 20 (step S3, Yes), the processing shown in the flowchart is terminated.

On the other hand, if the display determination unit 113 detects that the portable terminal 30 has not separated from the display device 20 (step S3, No), it determines whether or not to display desired content on the display device 20 (step S4). The method for causing the display determination unit 113 to determine whether or not to display desired content on the display device 20 will be described in detail below.

If the display determination unit 113 determines roes to display desired content on the display device 20 (step S4, Yes), the desired content is transmitted to the display device 20 via the transmission unit 114 and the delivery control device (step S5).

On the other hand, if the display determination unit 113 determines to not display desired content on the display device 20 (step S4, No), the process returns to the processing described in step S3.

Here, a case where the display determination unit 113 determines to display desired content on the display device 20 is described using FIG. 7(a).

As shown in FIG. 7(a), it is assumed that a portable terminal 30 at a position P1 moves from the position P1 in a direction indicated by the direction D1 to a position P2, which is inside the judgment area E. Furthermore, it is assumed that a display surface 20A is installed on one side of the display device 20. In the following description, the side on which the display surface 20A of the display device 20 is installed is referred to as the front, and the other side on which the display surface 20A is not installed is referred to as the rear.

Because the portable terminal 30 moves inside the judgment area E upon moving to the position P2, it is detected in step S1 of FIG. 6 that the portable terminal 30 has approached the display device 20.

Furthermore, if the portable terminal 30 moves from the position P1 to the position P2, the gaze of the user carrying the portable terminal 30 is considered to be in a direction from the position P1 toward the position P2. In this case, if there are no obstructions between the user and the display device 20, the probability that the display surface 20A is in the user's field of view is considered to be high. In this manner, the display determination unit 113 determines whether or not to display desired content on the display device 20 based on the history of the terminal position information and by detecting the movement direction of the portable terminal 30. Specifically, when the movement direction of the portable terminal 30 and the direction from the front of the display device 20 toward the rear are approximately equivalent directions, the display determination unit 113 determines that desired content is to be displayed on the display device 20.

In terms of determining whether or not the movement direction of the portable terminal 30 and the direction from the front of the display device 20 toward the rear are approximately equivalent directions, the determination may be made based on the size of the display surface 20A, the height of the installation position of the display surface 20A and the like, or based on a preset threshold for each display device 20. In this case, for example, when the portable terminal 30 moves from the position P2 in the direction D2, the display determination unit 113 determines to not display desired content on the display device 20. On the other hand, if the portable terminal 30 moves from the position P2 in a direction D3 or a direction D4, the display determination unit 113 determines to display desired content on the display device 20.

Furthermore, a case where the display determination unit 113 determines to not display desired content on the display device 20 will be described using FIG. 7(b).

As shown in FIG. 7(b), it is assumed that the portable terminal 30 at a position P3 moves from the position P3 in a direction indicated by the direction D5, and moves to a position P4 inside the area of the judgment area E. Because the portable terminal 30 enters the judgment area E upon moving to position P4, it is detected in step S1 of FIG. 6 that the portable terminal 30 has approached the display device 20.

However, if the portable terminal 30 moves from the position P3 to a position P4, the gaze of the user carrying the portable terminal 30 is considered to be in a direction from the position P3 toward the position P4. Therefore, the display surface 20A is blocked by the rear of the display device 20, and the display surface 20A is considered to be outside of the user's field of view. In this case, the display determination unit 113 determines to not display desired content on the display device 20. Specifically, the display determination unit 113 uses the history of the terminal position information to detect the movement direction of the user carrying the portable terminal 30, and determines to not display desired content on the display device 20 when the movement direction is in an approximately opposite direction to the direction from the front of the display device 20 toward the rear.

Furthermore, it is assumed that the portable terminal 30 at the position P4 additionally moves from the position P4 toward a direction indicated by the direction D6, and moves to a position P5 inside the area of the judgment area E. In this case, the display device 20 is no longer present on the forward side of the movement direction of the user carrying the portable terminal 30. Consequently, the display surface 20A is outside of the user's field of view. In this case, the display determination unit 113 determines to not display desired content on the display device 20. That is to say, even if the portable terminal 30 enters the judgment area E, if the display device 20 is not present on the forward side of the movement direction of the portable terminal 30, or if the movement direction of the portable terminal 30 is in an approximately opposite direction to the direction from the front of the display device 20 toward the rear surface, the display determination unit 113 determines to not display desired content on the display device 20.

Further, it is assumed that the portable terminal 30 in the position P5 additionally moves from the position P5 in a direction indicated by the direction D7 and moves outside the area of the judgment area E. In this case, because the portable terminal 30 leaves the judgment area E, it is detected in step S3 of FIG. 6 that the portable terminal 30 has separated from the display device 20.

As described above, the selection unit 112 selects desired content based on preset area information associated with the display device 20, and preset desire information associated with the portable terminal 30. As a result, the display method of the display system 1 capable of displaying desired content on the display device 20, wherein the content belongs to a category whose acquisition is desired by the user of the portable terminal 30, and the content is for the area related to the installation location of the display device 20. That is to say, the display method of the display system 1 is capable of displaying content on a display device which is appropriate for the user of the portable terminal 30.

Furthermore, the selection unit 112 selects the desired content to be displayed on the display device 20 after the detection step carried out by the detection unit 111. As a result, because the desired content is selected after detecting that the portable terminal 30 has approached the display device 20, the display method of the display system 1 is capable of displaying desired content on the display device with an appropriate timing such that the user of the portable terminal 30 has approached the portable terminal 30.

Furthermore, the selection unit 112 selects the desired content based on the history of the terminal position information. Consequently, the display method of the display system 1 is capable of selecting desired content using desire information such as the stores which are frequently visited by the user of the portable terminal 30, enabling more appropriate desired content to be displayed on the display device 20.

Moreover, the selection unit 112 selects the desired content based on the area selected from among the area information for a plurality of areas according to the terminal position information history. As a result, the display method of the display system 1 is capable of selecting the desired content using, for example, area information for an area that the user of the portable terminal 30 frequently passes through, enabling more appropriate desired content to be displayed on the display device 20.

In addition, if the portable terminal 30 enters the judgment area E set around the display device 20, the detection unit 111 detects that portable terminal 30 has approached the display device 20. Consequently, the display method of the display system 1 is capable of displaying desired content on the display device 20 when the user of the portable terminal 30 is near the display device 20, enabling desired content to be displayed on the display device 20 with a more appropriate timing.

Furthermore, the display determination unit 113 determines whether or not desired content is to be displayed on the display device 20 based on at least either terminal position information or the movement direction of the portable terminal 30. As a result, the display method of the display system 1 is capable of displaying desired content on the display device 20 when the display surface 20A of the display device 20 enters the field of view of the user of the portable terminal 30.

Moreover, the transmission unit 114 displays desired content on the display device 20 based on the determination result of the display determination unit 113 via the delivery control device 12 and the network 40. Consequently, the display method of the display system 1 is capable of displaying desired content on the display device 20 with a more appropriate timing.

In addition, the selection unit 112 selects desired content based on the area selected from among the area information for a plurality of areas according to a preset ranking for each area. As a result, the display method of the display system 1 is capable of selecting desired content using area information of an area with a high ranking, enabling more appropriate desired content to be displayed on the display device 20.

Furthermore, the selection unit 112 selects desired content based on, among the area information for a plurality of areas, the area selected according to the history of the terminal position information and a preset ranking for each area. Consequently, for example, the display method of the display system 1 is capable of selecting, among stores which are frequently visited by the user of the portable terminal 30, a store included in the area information for an area set with a high ranking as desired content. Moreover, the administrator or the like that sets the ranking for each area, for example, is capable of determining the ranking according to the installation location and the installation orientation of the display device 20 and the like, and also by predicting the movement direction of the user of the portable terminal 30. As a result, the display method of the display system 1 is capable of displaying more appropriate desired content on the display device 20.

In addition, when the desired content is selected, the selection unit 112 may determine whether or not area information is used based on information set beforehand by the user of the portable terminal 30. Consequently, the desired content may be selected according to whether or not the user desires the use of area information.

Furthermore, the selection unit 112 may select desired content based on attribute information such as the user's age and gender, and information such as the user's first language (the user's most proficient language, often referred to as a mother tongue) that are stored in the desire information DB 13A. As a result, in the present exemplary embodiment, content that corresponds to the user's age, gender, and the like, can be selected and displayed on the display device 20.

Moreover, the information receiving unit 110 may receive the terminal position information from the portable terminal 30, or may receive information from the display device 20 that indicates that the portable terminal 30 has approached the display device 20. As a result of the information receiving unit 110 receiving information from the display device 20 that indicates that the portable terminal 30 has approached the display device 20, it is not necessary to analyze terminal position information from the portable terminal 30 to detect that the portable terminal 30 has approached the display device 20, and the detection unit 111 becomes unnecessary. In addition, because it is not necessary to receive terminal position information from individual terminal devices 30 via the network 40, the load on the network 40 can be reduced.

### Second Exemplary Embodiment

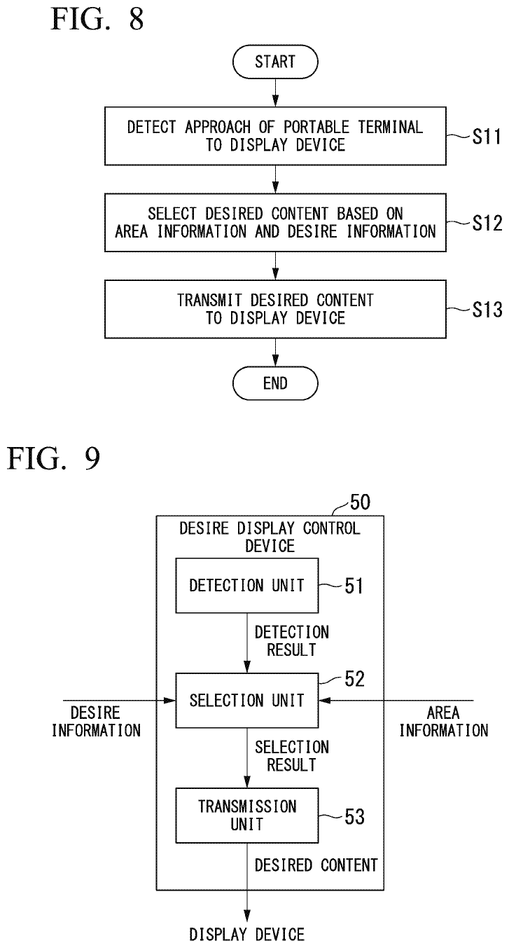

Next, a display method of a display system 1 according to a second exemplary embodiment will be described. FIG. 8 is a flowchart showing an operation of the display method of the display system 1 according to the second exemplary embodiment. In the present exemplary embodiment, the display system 1 includes, for example, a desire display control device 11 that selects desired content to be displayed on a display device 20.

The desire display control device 11 detects that a portable terminal 30 has approached the display device 20 (step S11). Then, the desire display control device 11 selects desired content based on area information and desire information. Then, the desire display control device 11 transmits the desired content to the display device 20 (step S13).

As described above, the display system 1 according to the second exemplary embodiment selects the desired content which is desired by the user of the portable terminal 30 with a timing such that the portable terminal 30 has approached the display device, and displays the selected desired content on the display device 20. Consequently, the display system 1 according to the second exemplary embodiment is capable of displaying content on a display device which is appropriate for passersby that pass near the display device.

### Third Exemplary Embodiment

Next, a desire display control device (display control device) 50 according to a third exemplary embodiment will be described. FIG. 9 is a configuration diagram showing the configuration of the desire display control device 50 according to the third exemplary embodiment. In the present exemplary embodiment, the desire display control device 50 includes a detection unit 51, a selection unit 52, and a transmission unit 53.

The detection unit 51 detects that a portable terminal 30 has approached a display device 20 based on terminal position information from the portable terminal 30 and installation position information of the display device 20 recorded in a display device DB 13B. If the detection unit 51 detects that the portable terminal 30 has approached the display device 20, the selection unit 52 selects desired content based on area information which has been set in association with the display device 20, and desire information which has been set in association with the portable terminal 30. The transmission unit 53 transmits the desired content selected by the selection unit 52 to the display device 20.

As described above, in the desire display control device 50 (an example of a “display control device”) according to the third exemplary embodiment, if the selection unit 52 detects that the portable terminal 30 has approached the display device 20, the desired content is selected based on preset area information associated with the display device 20 and preset desire information associated with the portable terminal 30, and the transmission unit 53 transmits the desired content selected by the selection unit 52 to the display device 20. Consequently, the desire display control device 50 according to the third exemplary embodiment is capable of displaying on the display device 20 content which is desired to be viewed by the user of the portable terminal 30, and content which is appropriate for the area related to the installation location of the display device 20.

Furthermore, the desire display control device 50 according to the third exemplary embodiment further includes the detection unit 51 that detects that the portable terminal 30 has approached the display device 20, based on installation position information (an example of “position information of the display device”) of the display device 20, and terminal position information (an example of “position information of the portable terminal”) of the portable terminal 30. As a result, in addition to the effects described above, the desire display control device 50 according to the third exemplary embodiment is capable of displaying desired content on the display device 20 with an appropriate timing such that the user of the portable terminal 30 has approached the display device 20.

### Fourth Exemplary Embodiment

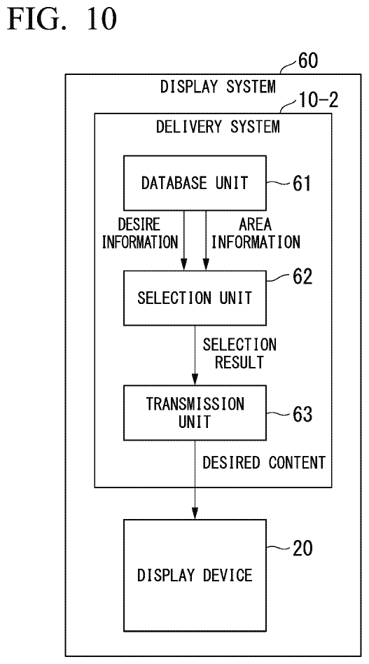

Next, a display system 60 according to a fourth exemplary embodiment will be described. FIG. 10 is a configuration diagram showing the configuration of the display system 60 according to the fourth exemplary embodiment. In the present exemplary embodiment, the display system 60 includes a delivery system 10-2 and a display device 20. The delivery system 10-2 includes a database unit 61, a selection unit 62, and a transmission unit 63. The display device 20 displays desired content transmitted from the delivery system 10-2.

The database unit 61 records preset area information associated with the display device 20 and preset desire information associated with a portable terminal 30. The selection unit 62 selects desired content based on area information and desire information recorded in the database unit 61. The transmission unit 63 transmits the desired content selected by the selection unit 62 to the display device 20.

Consequently, in the display system 60 of the present exemplary embodiment, because the database unit 61 records area information and desire information beforehand, the selection unit 62 is capable of selecting desired content based on information recorded in the database unit 61. Furthermore, because the transmission unit 63 transmits desired content selected by the selection unit 62 to the display device 20, the display device 20 is capable of displaying desired content. As a result, the display system 60 of the present exemplary embodiment is capable of displaying on the display device 20 content which is desired to be viewed by the user of the portable terminal 30, and content which is appropriate for the area related to the installation location of the display device 20.

Exemplary embodiments of the present invention have been described above with reference to the drawings. However, specific configurations are in no way limited to these exemplary embodiments, and design aspects and the like within a scope not departing from the spirit of the present invention are also included.

Several exemplary embodiments of the present invention have been described. However, these exemplary embodiments were presented as examples and are not intended to limit the scope of the invention. The exemplary embodiments may be implemented in various other forms, and various omissions, substitutions, and changes may be made within a scope not departing from the spirit of the invention. The exemplary embodiments and modified examples are included in the scope and spirit of the invention, and are also included in the scope of the invention as set forth in the claims or an equivalent scope thereof.

### INDUSTRIAL APPLICABILITY

The display method described above is capable of being utilized as a display method used in occupations in the advertising business and the like, which require particularly suitable content to be displayed on a display device.

### REFERENCE SYMBOLS

1 Display system
10, 10-2 Delivery system
11, 50 Desire display control device
110 Information receiving unit
111, 51 Detection unit
112, 52, 62 Selection unit
113 Display determination unit
114, 53, 63 Transmission unit
12 Delivery control device
13 Database
13A Desire information DB
13B Display device DB
13C Content DB
20 Display device
30 Portable terminal
40 Network
60 Display system
61 Database unit

1. A display method comprising:
detecting that a portable terminal has approached a display device;
selecting desired content to be displayed on the display device based on preset area information associated with the display device and preset desire information associated with the portable terminal, wherein the selecting is performed after the detecting; and
transmitting the selected desired content selected to the display device.

2. The display method according to claim 1, wherein the desired content is content selected based on history of a position of the portable terminal.

3. The display method according to claim 2,
wherein the area information comprises information indicating a plurality of areas, and
the desired content is content selected based on an area that is selected according to the history of the position, among the plurality of areas.

4. The display method according to claim 1, wherein, in the detecting, when the portable terminal enters a judgment area set around the display device, it is detected that the portable terminal has approached the display device.

5. The display method according to claim 1, further comprising:
determining whether or not to display the desired content on the display device, based on information of at least either of: a position of the portable terminal with respect to the display device; or a movement direction of the portable terminal with respect to the display device.

6. The display method according to claim 5, further comprising:
displaying the desired content on the display device, wherein the displaying is performed after the determining.

7. The display method according to claim 1,
wherein the area information includes information indicating a plurality of areas having a predetermined ranking for each area, and
the desired content is content selected based on an area that is selected according to the ranking, among the plurality of areas.

8. The display method according to claim 7, wherein the desired content is content selected based on the area selected according to the ranking and position history of the portable terminal.

9. The display method according to claim 1, further comprising:
performing beforehand a setting such that the desired content is selected based on the area information.

10. A display control device comprising:
a selection unit that, when it is detected that a portable terminal has approached a display device, selects desired content based on preset area information associated with the display device and preset desire information associated with the portable terminal; and
a transmission unit that transmits, to the display device, the desired content selected by the selecting unit.

11. The display control device according to claim 10, further comprising:
a detection unit that detects that the portable terminal has approached the display device, based on position information of the display device and position information of the portable terminal.

12. A display system comprising a delivery system, and a display device that displays desired content transmitted from the delivery system,
wherein the delivery system comprises:
a recording unit that records preset area information associated with the display device and preset desire information associated with a mobile terminal;
a selection unit that selects desired content based on the area information and the desire information; and
a transmission unit that transmits the desired content to the display device.
